(19) United States
(12) Patent Application Publication
(10) Pub. No.: US 2026/0279028 A1
(43) Pub. Date: Sep. 17, 2026

(54) OPEN-WORLD OBJECT DETECTION SYSTEM

(71) Applicant: Robert Bosch GmbH, Stuttgart (DE)

(72) Inventors: Suphanut JAMONNAK, Santa Clara, CA (US); Jiajing GUO, Mountain View, CA (US); Wenbin HE, Sunnyvale, CA (US); Thang DOAN, San Francisco, CA (US); Liang GOU, San Jose, CA (US); Liu REN, Saratoga, CA (US)

(21) Appl. No.: 19/078,967

(22) Filed: Mar. 13, 2025

(51) Int. Cl. G06V 10/778; G06V 10/74; G06V 10/762; G06V 10/764; G06V 10/77; G06V 10/774; G06V 10/82

(52) U.S. Cl. CPC G06V 10/7788; G06V 10/761; G06V 10/762; G06V 10/764; G06V 10/7715; G06V 10/774; G06V 10/82

(57) ABSTRACT

Methods for training and executing an open-world object detection system are disclosed. An object detection model of the system is executed to output bounding boxes pertaining to known and unknown object classes. The unclassified (e.g., unknown) bounding boxes are organized into clusters and then provided to a user, who subsequently provides one or more text-based pseudo labels for the unclassified bounding boxes. The original set of bounding boxes and the text-based pseudo labels are then used to train a classifier to classify the remaining objects. The use of the object detection model in conjunction with the classifier thus augments a total number of object classes that can be classified by the open-world object detection system.

### TECHNICAL FIELD

The present disclosure relates to methods and systems for applying machine learning techniques to enable an open-world object detection system.

### BACKGROUND

Open-world object detection is an emerging challenge in computer vision, which encompasses the identification of predefined object classes and also of unknown objects. The application of end-to-end, deep learning models have further improved upon the development of open-world object detection models. However, these approaches encounter several obstacles.

For example, most previous implementations of open-world object detection models required significant changes in neural network architecture and in training procedures in comparison compared to traditional object detection approaches. Those open-world object detection models were trained from scratch, meaning that they do not leverage the advantages of existing and widely available object detection models. Moreover, fine-tuning open-world object detection models requires a large number of annotations for all unknown classes, making previous implementations cumbersome, time-consuming, and limited.

### SUMMARY

In an embodiment, a method for training and executing an open-ended object detection system is provided. The method includes: executing an object detection model to output bounding boxes from image-based data samples; determining a first subset of the bounding boxes that correspond to known object classes of the object detection model; determining a second subset of the bounding boxes that correspond to unknown object classes of the object detection model; organizing the bounding boxes into clusters, wherein respective ones of the bounding boxes the clusters have shared semantic meanings; providing a portion of the clusters to a computing device of a user that corresponds to the unknown object classes of the object detection model; receiving, from the computing device of the user, data indicating text-based pseudo-labels for the portion of the clusters; training a classifier to learn additional object classes based on the data indicating the text-based pseudo-labels, the first subset of the bounding boxes, and the second subset of bounding boxes; and providing the learned, additional object classes to the open-world object detection system to augment a total number of known object classes of the open-world object detection system.

In another embodiment, a system including a processor and memory containing instructions that, when executed by the processor, cause the processor to perform these steps.

In another embodiment, a non-transitory computer-readable medium includes instructions that, when executed by a processor, cause the processor to perform these steps.

### BRIEF DESCRIPTION OF THE DRAWINGS

FIG. 1 illustrates a system for training and utilizing a machine learning model, according to some embodiments.

FIG. 2 illustrates a computer-implemented method for training and utilizing a machine learning model, according to some embodiments.

FIG. 3A illustrates a workflow diagram for an open-world object detection system during training of a classifier for the system, according to some embodiments.

FIG. 3B illustrates a workflow diagram for the open-world object detection system during inference of the system, according to some embodiments.

FIG. 4 illustrates an example of executing the open-world object detection system to identify objects within both known and unknown classes of an object detection model, according to some embodiments.

FIGS. 5A, 5B, 5C, and 5D collectively illustrate a portion of an execution of an open-world object detection system in which the object detection model determines both known and unknown classes of objects within a set of image-based data samples, according to some embodiments.

FIG. 6 illustrates a process of clustering, filtering, and ranking multiple unknown classes of objects, wherein the open-world object detection system determined that the image-based data samples include unknown classes of objects, according to some embodiments.

FIG. 7A illustrates a first portion of a user interface in which a user can view clusters of image-based data samples with unknown classes of objects within the images, according to some embodiments.

FIG. 7B illustrates a second portion of the user interface in which the user can view a plot of the projection of unknown classes of objects with respect to their feature vectors, according to some embodiments.

FIG. 7C illustrates a third portion of the user interface, wherein the user can view annotations to the unknown classes of objects, according to some embodiments.

FIG. 7D illustrates a fourth portion of the user interface, wherein the user can view performance metrics of the open-world object detection system, according to some embodiments.

FIG. 7E illustrates a fifth portion of the user interface in which statistics may be viewed by the user, according to some embodiments.

FIG. 8 is a flow diagram that illustrates a process of training a classifier for an open-world object detection system, according to some embodiments.

FIG. 9 is a table that illustrates the use of known classes of objects from the PASCAL VOC training dataset and unknown classes of objects from the Microsoft Common Objects in Context (MSCOCO) dataset during a given implementation of the open-world object detection system, according to some embodiments.

FIGS. 10A, 10B, 10C, and 10D illustrate various moments in time during a process of identifying and annotating giraffes, based on the given implementation of the open-world object detection system introduced in FIG. 9, according to some embodiments.

FIG. 11 is a table that illustrates performance during the given implementation of the open-world object detection system introduced in FIG. 9, wherein the system is measured using an F1 metric, according to some embodiments.

FIG. 12 is a table that illustrates performance during the given implementation of the open-world object detection system introduced in FIG. 9, wherein the system is measured using a mean average precision (mAP) metric, according to some embodiments.

FIG. 13 illustrates a schematic diagram of an interaction between a computer-controlled machine and a control system, according to some embodiments.

FIG. 14 depicts a schematic diagram of the control system of FIG. 13 configured to control a vehicle, which may be a partially autonomous vehicle, a fully autonomous vehicle, a partially autonomous robot, or a fully autonomous robot, according to some embodiments.

FIG. 15 depicts a schematic diagram of the control system of FIG. 13 configured to control a manufacturing machine, such as a punch cutter, a cutter, or a gun drill, of a manufacturing system, such as part of a production line, according to some embodiments.

FIG. 16 depicts a schematic diagram of the control system of FIG. 13 configured to control a power tool, such as a power drill or driver, that has an at least partially autonomous mode, according to some embodiments.

FIG. 17 depicts a schematic diagram of the control system of FIG. 13 configured to control an automated personal assistant, according to some embodiments.

FIG. 18 depicts a schematic diagram of the control system of FIG. 13 configured to control a monitoring system, such as a control access system or a surveillance system, according to some embodiments.

FIG. 19 depicts a schematic diagram of the control system of FIG. 13 configured to control an imaging system, for example an MRI apparatus, x-ray imaging apparatus, or ultrasonic apparatus, according to some embodiments.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative bases for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical application. Various combinations and modifications of the features consistent with the teachings of this disclosure, however, could be desired for particular applications or implementations.

“A”, “an”, and “the” as used herein refers to both singular and plural referents unless the context clearly dictates otherwise. By way of example, “a processor” programmed to perform various functions refers to one processor programmed to perform each and every function, or more than one processor collectively programmed to perform each of the various functions.

Open-world object detection is a machine learning technique within a larger field of computer vision that pertains towards detecting known and unknown object classes within image-based data samples.

In the past, incomplete versions of object detection models were trained to recognize object classes that are predefined in the training dataset. However, those object detection models often misclassified unknown objects, mistakenly identifying them as part of predefined classes instead. For example, an unseen animal on the road might have been misclassified as a car. This severe limitation restricted the application of such models into safety-critical domains, such as security surveillance, autonomous driving, and robotics. In autonomous driving, for example, an object detection model within a vehicle needs to be able to accurately recognize and respond to unexpected objects or obstacles, such as road debris or animals. Incorrect classifications could have consequences in such environments.

In contrast, and to address these challenges, the open-world object detection systems described herein are configured to identify known object classes and unknown object classes by allowing for a possibility that a given image-based data sample includes a previously unseen or unanticipated object with respect to those seen during a training phase of the system. Once an object detection model of the open-world object detection system has identified potential unknown objects, using bounding boxes, the processors that are executing the system are further configured to cluster and rank those particular bounding boxes and provide them to a user for review. The user returns a minimum amount of text-based pseudo-labels that pertain to an object class of those bounding boxes, and then the system is configured to train a classifier to recognize that image class. By training the classifier, the open-world object detection systems described herein are able to augment a total number of “known” object classes of the object detection model, thus improving performance and widening applicability.

The following description continues with a general introduction to machine learning techniques that are relevant to the methods for utilizing machine learning models, such as those described herein. Next, various embodiments of the architecture and process flow of jointly executing an object detection model and a classifier for an open-world object detection system are discussed. The present disclosure then demonstrates the versatility of the methods and systems described herein for incorporation into various technologies and larger systems.

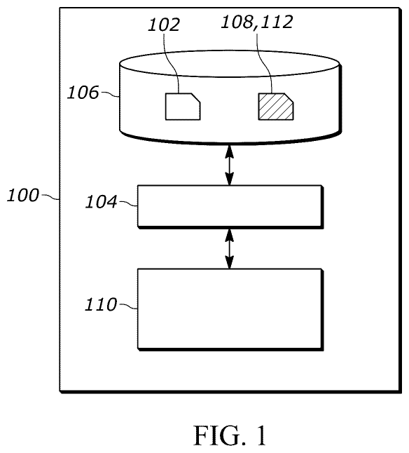

FIG. 1 illustrates a system 100 for training and utilizing a machine learning model, such as a convolutional neural network, according to some embodiments.

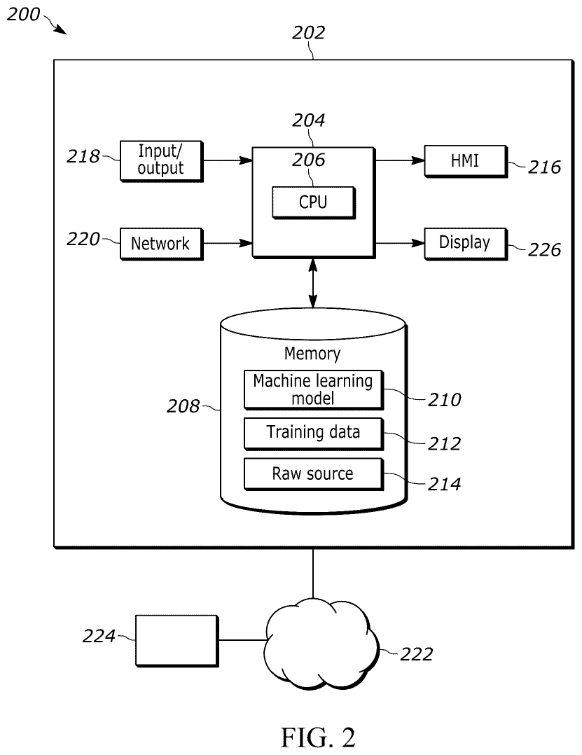

It should be understood that, while the example embodiments given in the following paragraphs herein with regard to FIGS. 1 and 2 refer to a convolutional neural network, additional embodiments of FIGS. 1 and 2 may be applied to any other type of neural-network-based or non-neural-network-based machine learning model that is configured to be developed, trained, fine-tuned, and/or executed for various applications of computer vision and object detection that are further described herein.

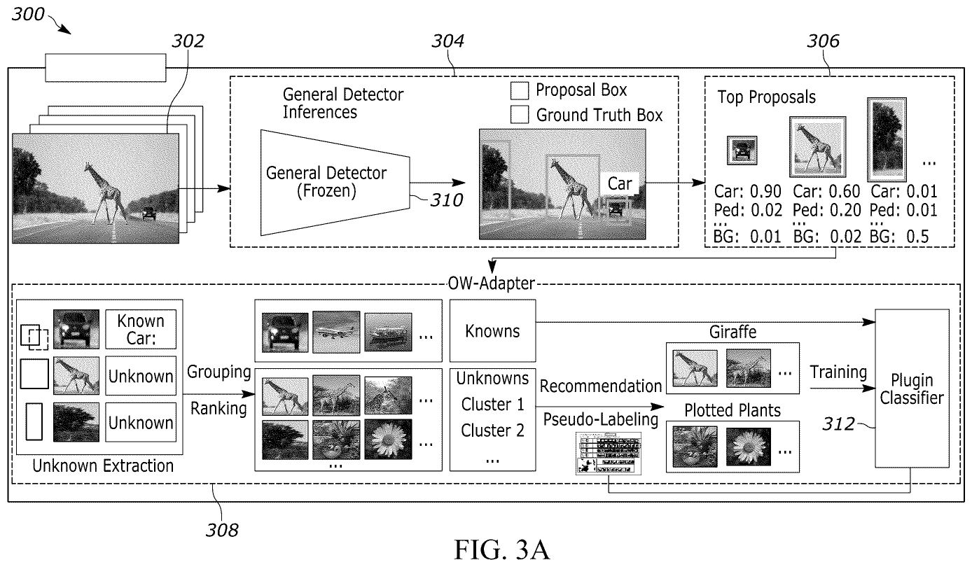

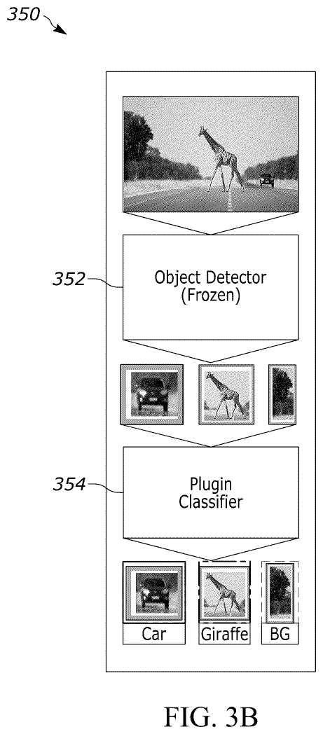

Moreover, FIGS. 1 & 2 may relate to one or more different moments in time than moments in time illustrated in FIG. 3A-12. The following paragraphs describe a training process for machine learning models, such as neural networks, such that context for the trained object detection model that is later described, for example, is thus provided. As FIG. 3A-12 pertain to a pre-trained object detection model, the model itself may be configured to utilize different types of neural architecture, such as Transformers or convolutional neural networks. FIGS. 1 & 2 may additionally pertain to a training of a classifier, which is implemented using a neural network. The usage of training a classifier is additionally described with regards to FIG. 3A-12 below.

In some embodiments, the system 100 may comprise an input interface for accessing training dataset 102 for the convolutional neural network. For example, as illustrated in FIG. 1, the input interface may be constituted by a data storage interface 104 which may access the training data 102 from a data storage 106. For example, the data storage interface 104 may be a memory interface or a persistent storage interface, e.g., a hard disk or an SSD interface, but also a personal, local or wide area network interface such as a Bluetooth, ZigBee or Wi-Fi interface or an Ethernet or fiber optic interface. The data storage 106 may be an internal data storage of the system 100, such as a hard drive or SSD, but also an external data storage, e.g., a network-accessible data storage.

In some embodiments, the data storage 106 may further comprise a data representation 108 of an untrained version of the model (e.g., a version of the machine learning model that has yet to be trained) which may be accessed by the system 100 from the data storage 106. It will be appreciated, however, that the training data 102 and the data representation 108 of the pre-trained convolutional neural network may also each be accessed from a different data storage, e.g., via a different subsystem of the data storage interface 104. Each subsystem may be of a type as is described above for the data storage interface 104. In other embodiments, the data representation 108 of the pre-trained convolutional neural network may be internally generated by the system 100 on the basis of design parameters for the neural network, and therefore may not explicitly be stored on the data storage 106.

The system 100 may further comprise a processor subsystem 110 which may be configured to, during operation of the system 100, provide an iterative function as a substitute for a stack of layers of the convolutional neural network to be trained. Here, respective layers of the stack of layers being substituted may have mutually shared weights and may receive, as input, an output of a previous layer, or for a first layer of the stack of layers, an initial activation, and a part of the input of the stack of layers. The processor subsystem 110 may be further configured to iteratively train and/or fine-tune the convolutional neural network using the training data 102 (e.g., thus generating updated versions of the machine learning model with respect to a first “pre-trained” version of the model). Here, an iteration of the training by the processor subsystem 110 may comprise a forward propagation part and a reverse, or generation, propagation part.

The system 100 may further comprise an output interface for outputting a data representation 112 of the trained convolutional neural network, and this data may also be referred to as trained model data 112. For example, as also illustrated in FIG. 1, the output interface may be constituted by the data storage interface 104, with said interface being in these embodiments an input/output (“IO”) interface, via which the trained model data 112 may be stored in the data storage 106. For example, the data representation 108 defining the ‘pre-trained’ convolutional neural network may during or after the training be replaced, at least in part by the data representation 112 of the trained neural network, in that the parameters of the convolutional neural network, such as weights, hyperparameters, and other types of parameters of convolutional neural networks, may be adapted to reflect the training on the training data 102. This is also illustrated in FIG. 1 by the reference numerals 108 and 112 referring to the same data record on the data storage 106. In other embodiments, the data representation 112 may be stored separately from the data representation 108 defining the ‘pre-trained’ convolutional neural network. In some embodiments, the output interface may be separate from the data storage interface 104, but may in general be of a type as described above for the data storage interface 104.

The system 100 shown in FIG. 1 is one example of a system that may be utilized to train and then subsequently execute the trained machine learning models described herein.

FIG. 2 illustrates a computer-implemented method for training and utilizing a convolutional neural network, according to some embodiments. The system 200 may include at least one computing system 202. The computing system 202 may include at least one processor 204 that is operatively connected to a memory unit 208. The processor 204 may include one or more integrated circuits that implement the functionality of a central processing unit (CPU) 206 and, in some embodiments, a graphics processing unit (GPU). The CPU 206 may be a commercially available processing unit that implements an instruction set such as one of the x86, ARM, Power, or MIPS instruction set families. During operation, the CPU 206 may execute stored program instructions that are retrieved from the memory unit 208. The stored program instructions may include software that controls operation of the CPU 206 to perform the operation described herein. In some examples, the processor 204 may be a system on a chip (SoC) that integrates functionality of the CPU 206, the memory unit 208, a network interface, and input/output interfaces into a single integrated device. The computing system 202 may implement an operating system for managing various aspects of the operation.

The memory unit 208 may include volatile memory and non-volatile memory for storing instructions and data. The non-volatile memory may include solid-state memories, such as NAND flash memory, magnetic and optical storage media, or any other suitable data storage device that retains data when the computing system 202 is deactivated or loses electrical power. The volatile memory may include static and dynamic random-access memory (RAM) that stores program instructions and data. For example, the memory unit 208 may store a machine learning model 210 or algorithm, a training dataset 212 for the machine learning model 210, raw source dataset 214, etc.

The computing system 202 may include a network interface device 220 that is configured to provide communication with external systems and devices. For example, the network interface device 220 may include a wired and/or wireless Ethernet interface as defined by Institute of Electrical and Electronics Engineers (IEEE) 802.11 family of standards. The network interface device 220 may include a cellular communication interface for communicating with a cellular network (e.g., 3G, 4G, 5G). The network interface device 220 may be further configured to provide a communication interface to an external network 222 or cloud.

The external network 222 may be referred to as the world-wide web or the Internet. The external network 222 may establish a standard communication protocol between computing devices. The external network 222 may allow information and data to be easily exchanged between computing devices and networks. One or more servers 224 may be in communication with the external network 222.

The computing system 202 may include an input/output (I/O) interface 218 that may be configured to provide digital and/or analog inputs and outputs. The I/O interface 218 may include additional serial interfaces for communicating with external devices (e.g., Universal Serial Bus (USB) interface).

The computing system 202 may include a human-machine interface (HMI) device 216 that may include any device that enables the system 200 to receive control input. Examples of input devices may include human interface inputs such as keyboards, mice, touchscreens, voice input devices, and other similar devices. The computing system 202 may include a display device 226. The computing system 202 may include hardware and software for outputting graphics and text information to the display device 226. The display device 226 may include an electronic display screen, projector, printer or other suitable device for displaying information to a user or operator. The computing system 202 may be further configured to allow interaction with remote HMI and remote display devices via the network interface device 220.

The system 200 may be implemented using one or multiple computing systems. While the example depicts a single computing system 202 that implements all of the described features, it is intended that various features and functions may be separated and implemented by multiple computing units in communication with one another. The particular system architecture selected may depend on a variety of factors.

The system 200 may implement a machine learning algorithm 210 that is configured to analyze the raw source dataset 214. The raw source dataset 214 may include raw or unprocessed sensor data that may be representative of an input dataset for a machine learning system. In some examples, the machine learning algorithm 210 may be a convolutional neural network algorithm that is designed to perform a predetermined function. For example, the neural network algorithm may be configured to receive image-based data samples, such as in the case of the object detection models additionally described below.

The computer system 200 may store a training dataset 212 for the machine learning algorithm 210. The training dataset 212 may represent a set of previously constructed data for training the machine learning algorithm 210. The training dataset 212 may be used by the machine learning algorithm 210 to learn weighting factors associated with a convolutional neural network algorithm. The training dataset 212 may include a set of source data that has corresponding outcomes or results that the machine learning algorithm 210 tries to duplicate via the learning process.

The machine learning algorithm 210 may be operated in a learning mode using the training dataset 212 as input. The machine learning algorithm 210 may be executed over a number of iterations using the data from the training dataset 212. With each iteration, the machine learning algorithm 210 may update internal weighting factors based on the achieved results. For example, the machine learning algorithm 210 can compare output results (e.g., annotations) with those included in the training dataset 212. Since the training dataset 212 includes the expected results, the machine learning algorithm 210 can determine when performance is acceptable. After the machine learning algorithm 210 achieves a predetermined performance level (e.g., 100% agreement with the outcomes associated with the training dataset 212), the machine learning algorithm 210 may be executed using data that is not in the training dataset 212. The trained machine learning algorithm 210 may be applied to new datasets to generate annotated data.

The machine learning algorithm 210 may be configured to identify a particular feature in the raw source data 214. The raw source data 214 may include a plurality of instances or input dataset for which annotation results are desired. The machine learning algorithm 210 may be programmed to process the raw source data 214 to identify the presence of the particular features. The machine learning algorithm 210 may be configured to identify a feature in the raw source data 214 as a predetermined feature. The raw source data 214 may be derived from a variety of sources. For example, the raw source data 214 may be actual input data collected by a machine learning system. The raw source data 214 may be machine generated for testing the system. As an example, the raw source data 214 may include image-based data samples that are relevant to a nearby visual environment of an autonomous or semi-autonomous vehicle.

In the example, the machine learning algorithm 210 may then process raw source data 214 and output an indication of which of the known, or unknown, object classes are supported by the image-based data samples. A machine learning algorithm 210 may generate a confidence level or factor for each output generated. For example, a confidence value that exceeds a predetermined high-confidence threshold may indicate that the machine learning algorithm 210 is confident that the identified feature corresponds to the particular feature. A confidence value that is less than a low-confidence threshold may indicate that the machine learning algorithm 210 has some uncertainty that the particular feature is present.

FIG. 3A illustrates a workflow diagram for an open-world object detection system during training of a classifier for the system, according to some embodiments.

Workflow 300 refers to a training phase of the open-world object detection system. As used herein, a training phase for the open-world object detection system, which includes at least an object detection model and a classifier, may be defined by a freezing of the pre-trained object detection model 310. During the freezing, internal weights and biases of the object detection model 310 are not changed or otherwise updated.

As shown in FIG. 3A, image-based data samples 302 are provided to object detection model 310. As shown in box 304, bounding boxes are output from object detection model 310, which may pertain to known or unknown object classes of the object detection model 310. As used herein, “bounding boxes” refer to image patches of the larger image-based data samples that have been initially provided to the object detection model, such as image-based data samples 302, which are provided to object detection model 310.

In a particular example shown in boxes 304 and 306, a first bounding box overlaps with a ground truth bounding box such that a “car” object class is identified, while a second bounding box that features a giraffe does not overlap with a ground truth bounding box. When a bounding box does not overlap with a ground truth bounding box, the bounding box corresponds to an unknown object class of the object detection model 310. Moreover, bounding boxes that represent unknown object classes include image patches that have semantic meaning or significance.

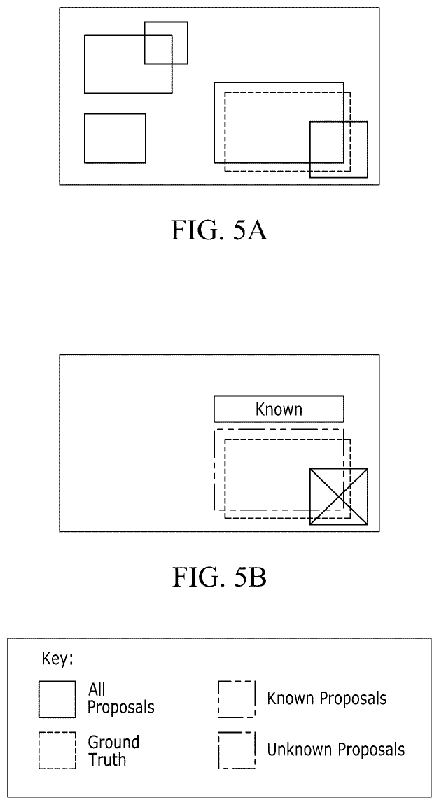

Additional examples of this step in workflow 300 are further described below with regard to FIG. 5A-5D.

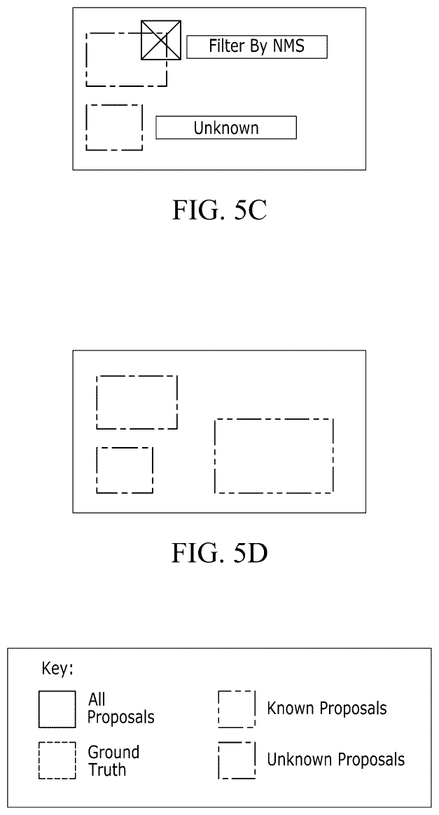

Continuing with workflow 300, a first subset of the bounding boxes that corresponds to known object classes and a second subset of the bounding boxes that corresponds to unknown object classes are grouped into clusters and ranked. This particular step in workflow 300 is additionally described below with regard to FIG. 6.

As shown in box 308 of FIG. 3A, the grouped and ranked clusters are then provided to a user, who provides text-based pseudo-labels of at least some of the image patches that correspond to unknown object classes of the object detection model 310. Text-based pseudo-labels refer to generalized words or short phrases (e.g., “giraffe,” “potted plants,” etc.) for unknown image classes.

The text-based pseudo-labels, the first subset of the bounding boxes, and the second subset of the bounding boxes are then provided to a classifier 312 for training. In some embodiments, classifier 312 resembles a lightweight classifier, such as a multi-layer perceptron (MLP). Classifier 312 may act as a “plug-in” to object detection model 310, such that a total number of known object classes of the object detection model 310 is augmented. For example, and as shown in the given iteration of workflow 300 in FIG. 3A, object detection model 310 classifies the giraffe image patch within an unknown object class. However, by incorporating text-based pseudo-labels about giraffes into the training of classifier 312, giraffes can now fall under a known object class of the larger open-world object detection system illustrated in FIG. 3 during the next iteration of workflow 300. As such, performance of classifier 312, and therefore the larger open-world object detection system, is progressively refined, iteration after iteration.

FIG. 3B illustrates a workflow diagram for the open-world object detection system during inference of the system, according to some embodiments.

Workflow 350 refers to an inference phase of the open-world object detection system. During inference, classifier 354 extends the known object classes of object detection model 352, such that a total number of known object classes of the open-world object detection system is augmented.

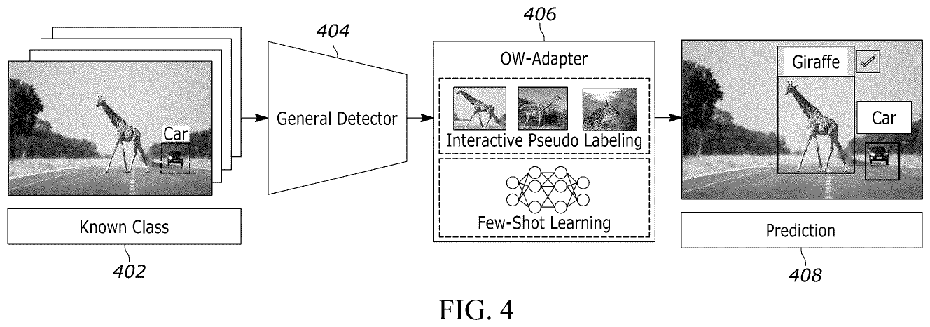

FIG. 4 illustrates an example of executing the open-world object detection system to identify objects within both known and unknown classes of an object detection model, according to some embodiments.

As shown in FIG. 4, the open-world object detection system includes an unknown-aware detection 402, unknown mining via the object detection model 404, human-in-the-loop, visual-analytics-assisted discovery 406; and online and offline feedback loops 408.

FIGS. 5A, 5B, 5C, and 5D collectively illustrate a portion of an execution of an open-world object detection system in which the object detection model determines both known and unknown classes of objects within a set of image-based data samples, according to some embodiments.

As shown in FIGS. 5A, 5B, 5C, and 5D, a given image-based data sample (actual features of the image removed for simplicity of discussion in what follows) has been processed by the object detection model. The Key in the figure is also meant to be used by the reader as a guide.

In FIG. 5A, the object detection model has been executed and has output five total bounding boxes for this particular image-based data sample. As made clear by the description of FIG. 5B-5D in the following paragraphs, a first subset of those bounding boxes correspond to known object classes of the object detection model, and a second subset of the bounding boxes correspond to unknown object classes of the object detection model. In addition, a sixth bounding box resembles a ground truth bounding box.

As shown in FIG. 5B, one of the five bounding boxes that has been output by the object detection model is determined to be within a known object class. More specifically, the given bounding box is identified as overlapping, at least above a threshold amount, with the ground truth bounding box. As the ground truth bounding box indicates a presence of one or more objects within a known object class of the object detection model, the open-world object detection system is configured to determine that the given bounding box in FIG. 5B falls under a known object class.

As additionally shown by the strikethrough bounding box in FIG. 5B, an additional bounding box overlaps with the ground truth box, but is removed from consideration. The system is configured to determine when to remove a bounding box from consideration based on a method of retaining the bounding box, out of the multiple bounding boxes, that has a highest alignment (e.g., maximum IoU) with the ground truth bounding box.

As shown in FIG. 5C, two more of the five bounding boxes that has been output by the object detection model are determined to be within unknown object classes. More specifically, the given bounding boxes are identified as not overlapping, at least not above a threshold amount, with the ground truth bounding box shown in FIG. 5B. As such, the open-world object detection system is configured to determine that the two bounding boxes in FIG. 5C fall under unknown object classes.

As additionally shown by the strikethrough bounding box in FIG. 5C, each of the bounding boxes of the five are measured by an objectness score. If a given objectness score is low, it may mean that the particular bounding box refers to an image patch that focuses on the background of the image, rather than the forefront. As such, the open-world object detection system is further configured to filter out one or more of the bounding boxes from the second subset that refers to unknown object classes when its corresponding objectness score is below a threshold value. In some embodiments, this may refer to a non-maximum suppression (NMS) techniques used to eliminate overlapping unknown bounding boxes, thus ensuring that relevant and distinct bounding boxes are retained for the next step in workflow 300.

FIG. 5D thus shows the results of the processing steps discussed with regard to FIG. 5A-5C, wherein three bounding boxes for this particular image-based data sample remain: one bounding box that has been determined to be within the known object classes of the object detection model, and two bounding boxes that have been determined to be within the unknown object classes of the object detection model.

FIG. 6 illustrates a process of clustering, filtering, and ranking multiple unknown classes of objects, wherein the open-world object detection system determined that the image-based data samples include unknown classes of objects, according to some embodiments.

Following the determination of bounding boxes that fall within known and unknown object classes of the object detection model (see description of FIGS. 5A-5D, for example), respective ones of the bounding boxes are clustered and ranked, before being provided to a user for inspection.

Process 600 firstly includes extracting feature vectors 604 from bounding boxes 602. For example, respective feature maps of the image-based data samples that were provided to the object detection model are obtained from an intermediate layer of the object detection model. Then, an average of these features is computed for respective ones of the bounding boxes, based on the feature maps. Finally, high-dimensional representations for the respective ones of the bounding boxes are output.

Process 600 then continues with projecting those high-dimensional representations into two-dimensional latent vectors. In the example shown in FIG. 6, Uniform Manifold Approximation and Projection (UMAP) 606 is used.

Next, the two-dimensional latent vectors are grouped into clusters based on their shared semantic meanings in the latent space. This is illustrated by clustering 608 in FIG. 6. In some embodiments, a k-means clustering may be applied with adjustable cluster numbers. For example, a given cluster may include bounding boxes that include image patches of cars, trucks, buses, motorbikes, etc., which are close in proximity to one another in the latent space, and belong to a vehicle object class.

Process 600 then continues by filtering out respective ones of the clusters that pertain to known object classes of the object detection model. This is illustrated by filtering 610 in FIG. 6.

Remaining clusters, post-filtering 610, thus pertain to the unknown object classes of the object detection model. As shown in the particular example in FIG. 6, three clusters remain, and, according to ranking 620, can be ranked by various means. In some embodiments, the remaining clusters may be ranked by a false positive rate, by entropy, or by maximum confidence. Each of those types of ranking may be enabled by the system, such that the user has multiple ways of viewing results of process 600.

As shown in the particular ranking 620 of FIG. 6, unknown cluster 622, which pertains to bounding boxes 612, is ranked highest, followed by unknown cluster 624 with bounding boxes 614, which is followed by unknown cluster 626 with bounding boxes 618. As introduced above, bounding boxes within each cluster share semantic meanings. For example, bounding boxes 612 have been identified by the system as sharing a particular semantic meaning that is a different semantic meaning from bounding boxes 614.

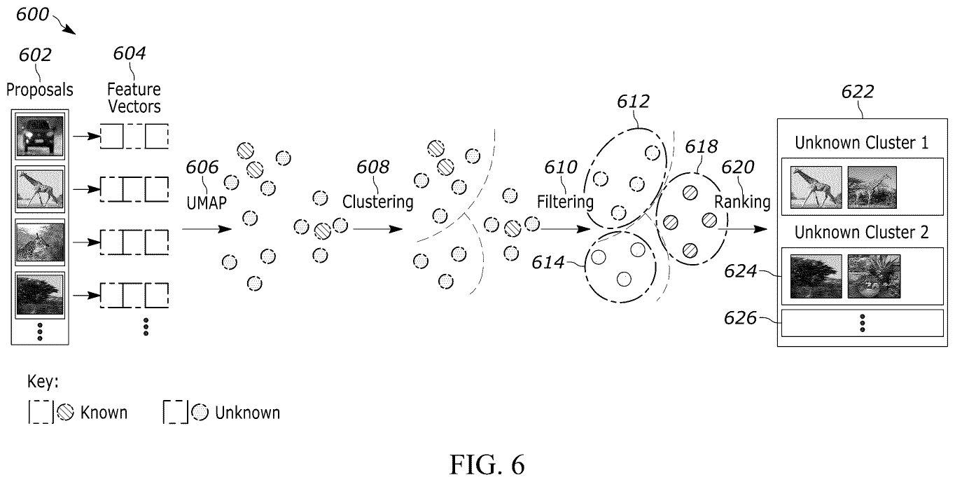

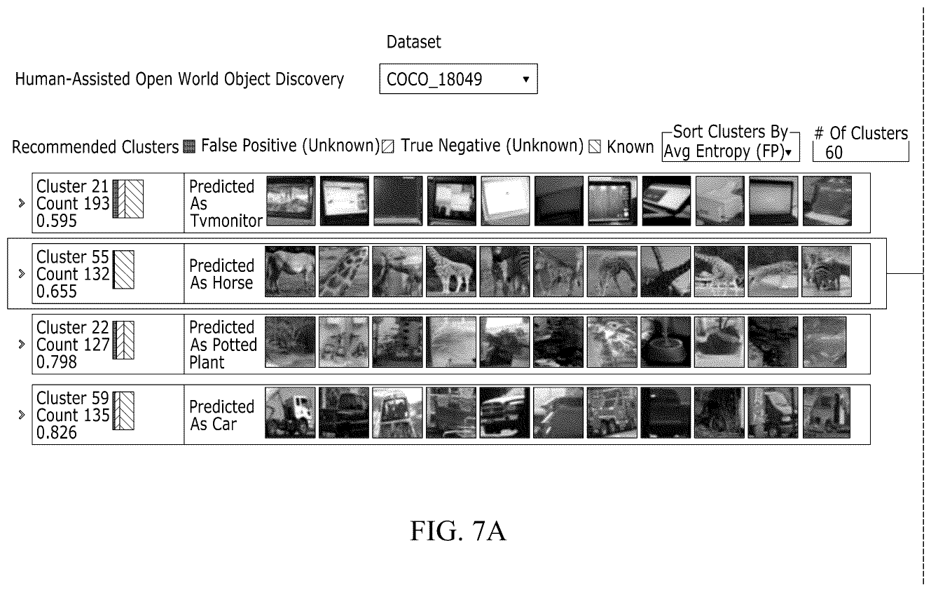

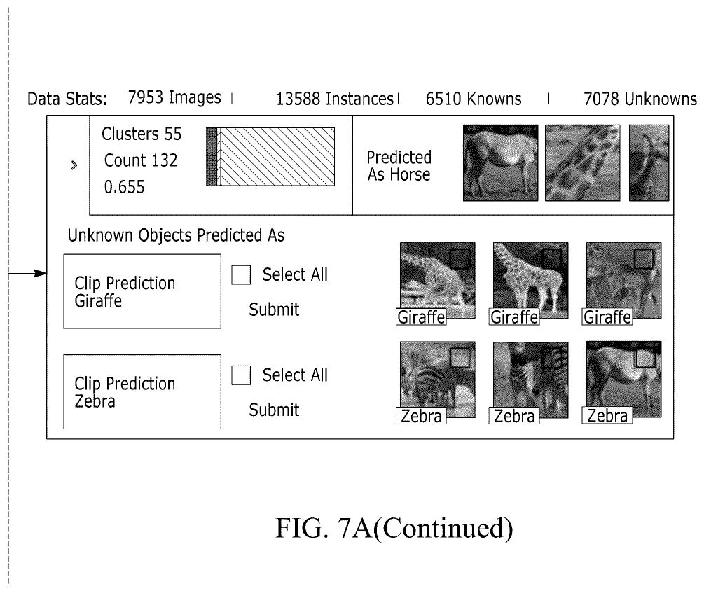

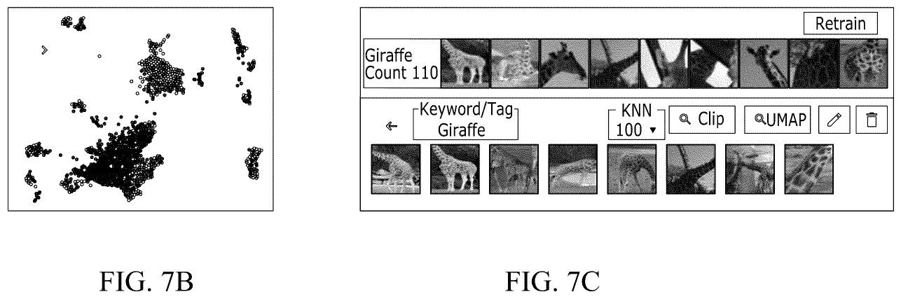

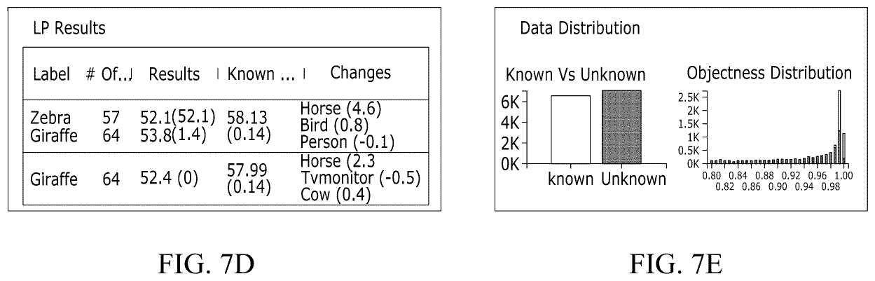

Continuing with example embodiments shown in FIG. 6, unknown clusters 622, 624, and 626 are then provided to a user, via a user interface (see also description pertaining to FIG. 7A-7E). A user may then provide at least one text-based pseudo-label for the clusters. Continuing with the example introduced above, if bounding boxes 612 include image patches of cars, trucks, etc., then the user may provide a text-based pseudo-label such as “vehicles” for unknown cluster 622.

Responsive to the system receiving, from the user, at least one text-based pseudo-label, the following Contrastive Language-Image Pretraining (CLIP)-based recommendation or patch feature-based recommendation processes may be performed by the system, thus both streamlining and minimizing the need for user inputs. The following recommendation processes may also be referred to as annotation processes.

In some embodiments in which a CLIP-based recommendation process is applied, a large vision-language model, such as CLIP, is executed to output a ranking of other bounding boxes within a same or different cluster. The newly ranked bounding boxes are then provided again to the user. Continuing with the example above, CLIP is used to identify other bounding boxes that likely belong to the text-based pseudo-label “vehicles.”

In order to perform this operation, the CLIP text encoder encodes the given text-based pseudo-label to generate a text embedding, and the CLIP image encoder encodes other bounding boxes within the same cluster to generate an image embedding. A cosine similarity is then computed between the text and image embeddings, and the other bounding boxes are then ranked based on that cosine similarity. A top-k bounding boxes may be selected (e.g., wherein k is set to 50) and provided to the user for further annotations and/or verifications.

In some embodiments in which a patch feature-based recommendation process is applied, other bounding boxes of the same cluster that are close to the initial bounding box in the two-dimensional projection space are identified and then provided to the user. As similar objects may share similar feature vectors, k-nearest neighbors may be identified within the embedding space and then merged, to eliminate duplicates.

Throughout the annotation processes, users may provide text-based pseudo-labels, but do not need to edit, change, or otherwise modify the bounding boxes themselves.

FIGS. 7A, 7B, 7C, 7D, and 7E illustrate portions of a user interface, according to some embodiments.

Throughout workflow 300, a user may view the determination of known and unknown object classes by the open-world object detection system via a user interface. This may be referred to as an open-world discovery interactive visual analytics dashboard. FIG. 7A-7E illustrate various portions of that user interface. For example, FIG. 7A illustrates clusters of unknown object classes, with a list of recommended clusters and a detailed view of a selected cluster. FIG. 7B illustrates a projection of the unknown object classes with respect to their feature vectors. FIG. 7C illustrates annotated known clusters and other recommended bounding boxes by the open-world object detection system. FIG. 7D illustrates a history of the system's performance changes over time. FIG. 7E illustrates summary statistics of the bounding boxes, such as objectness scores, patch sizes, etc.

The visual display of the user interface provides a concise overview of the clusters that include unknown objects in order to assist users in swiftly identifying, and naming via text-based pseudo-labels, potential unknown object classes. The clusters are generated and prioritized based on user-defined parameter settings, which can be adjusted using the control bar. The control bar comprises a color legend and various control parameters, including the minimum false positive rate, sorting method, and number of clusters. Once users have fine-tuned these parameters, they can generate and rank a new set of recommended clusters by simply clicking the submit button. This interactive feature allows users to efficiently explore and evaluate different cluster configurations according to their specific requirements and preferences.

Upon selecting a cluster of interest, users can explore detailed information about the cluster in the Cluster Detail View of FIG. 5A. This view presents the selected cluster in a similar manner to the recommended cluster view. Users have the ability to interactively choose a specific group of unknown image patches with the same prediction and visualize those selected image patches.

To enhance the identification of unknown object classes, the system is further configured to organize the bounding boxes within the cluster based on their CLIP prediction results. The subgroups are sorted based on the number of bounding boxes within each subgroup, and they are displayed row by row in the visualization. Respective rows represent given subgroups, and include the bounding boxes belonging to that particular subgroup. By clicking on any image patch, users can view the full image along with other bounding boxes.

To facilitate the annotation process, users have the option to select multiple image patches by clicking the checkbox located in the top-right corner of each image patch. Once they have made their selections, they can submit the chosen image patches as annotations. This interactive functionality allows users to efficiently explore the cluster, analyze individual bounding boxes, and curate their annotations (e.g., text-based pseudo-labels) according to their specific needs and preferences.

In FIG. 7B, a projection view of the user interface presents a scatter plot that visualizes the 2D projection of feature vectors from the given bounding boxes. Each dot in the scatter plot represents a bounding box, and its color indicates whether the bounding box belongs to a known object class or an unknown object class. To enhance user interaction, a lasso selection tool is provided in the projection view. This tool allows users to manually draw a shape around specific sub-clusters of interest. By utilizing the lasso selection, users can effectively isolate and explore particular subsets of bounding boxes based on their visual patterns or characteristics. Overall, the projection view offers an intuitive and interactive means to examine the distribution of bounding boxes in the two-dimensional feature space, providing insights into the separation between known and unknown objects and enabling targeted exploration of sub-clusters of interest.

In FIG. 7C, the statistic view of the user interface presents visualizations in the form of bar charts to depict the distributions of various attributes related to the bounding boxes. These attributes include objectness scores, sizes, prediction labels, and confidence scores. The bar charts distinguish between known bounding boxes and unknown bounding boxes. Users can interact with the statistic view by applying filters to the unknown objects. One way to filter is by using brushing techniques on the bar charts. For example, if users find that the extracted unknown bounding boxes are too small or blurry, impairing their ability to provide a clear visual representation of an object, they can define size thresholds within specific ranges to filter out such bounding boxes. The filtered unknown objects are then displayed and synchronized across different coordinated views, ensuring consistency and coherence across the visualizations. This interactive functionality empowers users to dynamically explore and analyze the distributions of bounding boxes based on different attributes, enabling them to gain insights and make informed decisions regarding the selection and filtering of unknown objects.

In FIG. 7D, the annotation view of the user interface presents a list of new classes with annotated examples organized in rows. Users can click on a specific row to focus on the annotations for that particular class. Once a class is selected, the view provides visualizations and tools for users to perform actions such as adding, editing, updating, and removing annotations. At the top of the annotation view, all the annotated examples for the selected class are displayed. Users can review and make changes to these examples as needed. Additionally, users have the option to expand their selection by utilizing either the CLIP or feature recommendation. By choosing one of these recommendation options, users can access a set of proposed examples for annotation. These recommended examples are visualized at the bottom of the annotation view. Users can selectively choose bounding boxes from the recommendations and add them to the annotated examples, effectively expanding the set of labeled data for the selected class. This iterative process enables users to enhance the training of the model by incrementally refining and expanding the annotations for each class of interest.

Once the user has selected the list of annotated examples, the system is configured to proceed with training the classifier. This trained classifier can then be used to evaluate the performance of the open-world object detection system. The results of this evaluation are presented in the model performance view of the user interface, in FIG. 7E. In this view, users can observe the historical changes in the model's performance over time.

The model performance view offers insights into how the model's performance has improved or evolved with the inclusion of additional annotated examples (e.g., over multiple iterations of workflow 300 in which the total number of known object classes of the open-world object detection system has been augmented over time). Users can identify areas where the model may benefit from further enhancement and detection of unknown objects.

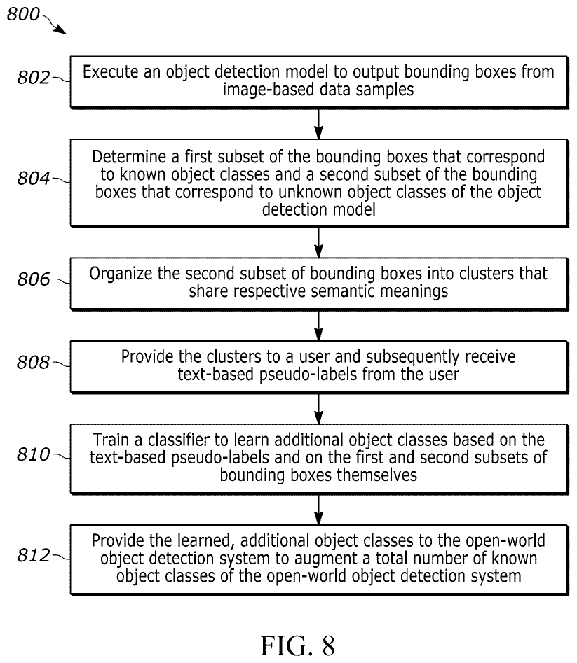

FIG. 8 is a flow diagram that illustrates a process of training a classifier for an open-world object detection system, according to some embodiments.

In some embodiments, process 800 may also refer to workflow 300, since FIGS. 3A and 8 refer to training phases of the open-world object detection system.

In block 802, an object detection model of the open-world object detection system is provided with image-based data samples and is then executed to output bounding boxes from those image-based data samples. As introduced above, and according to block 804, the open-world object detection system is then configured to determine that a first subset of the bounding boxes correspond to known object classes of the object detection model, while a second subset of the bounding boxes correspond to unknown object classes of the object detection model.

In block 806, the bounding boxes that pertain to known and unknown object classes are organized into clusters. As introduced above with regard to FIG. 5A-6, the clusters pertaining to known object classes are then removed from a total number of clusters that are to be presented to a user. With the remaining clusters, the system is configured to group the bounding boxes according to semantic meaning.

In block 808, the clusters are provided to the user, who subsequently provides at least one text-based pseudo-label to the system. In examples provided above, the text-based pseudo-label is a short word or phrase, such as “vehicles.”

In block 810, the first subset of the bounding boxes that pertain to known object classes, the second subset of the bounding boxes that pertain to the unknown object classes, and the one or more text-based pseudo-labels are combined into a training dataset that is then used to train a classifier of the open-world object detection system.

In some embodiments, the classifier refers to a lightweight classifier, such as an MLP, which is trained using a few-shot learning approach to classify the remaining unknown objects in the second subset of the bounding boxes that pertain to the unknown object classes. The MLP uses the feature vectors for respective bounding boxes as inputs to generate probabilities for membership into respective object classes. Moreover, since a number of text-based pseudo-labels is minimal, upsampling is applied to the one or more text-based pseudo-labels during training of the classifier.

In block 812, the classifier outputs one or more learned, additional object classes, which are then provided for use by the open-world object detection system to augment a total number of known object classes of the open-world object detection system. For example, if one of the new, learned object classes resembles classification of “vehicles,” then, during a subsequent iteration of process 800, the open-world object detection system will be able to classify bounding boxes that include various vehicles as positively including a vehicle due to the trained classifier.

Moreover, during inference phase (e.g., workflow 350) of the open-world object detection system, a total number of “known” object classes of the overall system is defined as the known object classes of the pre-trained object detection model, in addition to any additional learned object classes of the trained classifier, thus enhancing the overall capability of the system to classify a larger range of objects.

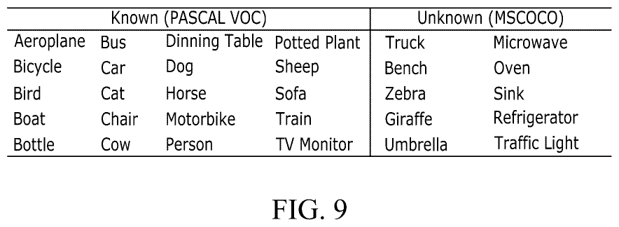

The following FIG. 9-12 illustrate an example implementation of the open-world object detection systems described herein.

FIG. 9 is a table that illustrates the use of known classes of objects from the PASCAL VOC training dataset and unknown classes of objects from the Microsoft Common Objects in Context (MSCOCO) dataset during a given implementation of the open-world object detection system, according to some embodiments.

In the example implementation of FIG. 9-12, the PASCAL VOC dataset is used for training, which includes 18,051 training images and 20 known object classes which serve to produce the ground truth bounding boxes introduced above. The open-world object detection system is evaluated using the Microsoft Common Objects in Context (MSCOCO) dataset, from which 4,000 images are used for validation and 10,246 images are used for testing. The MSCOCO dataset contains 80 object classes, wherein 20 of them are the same as PASCAL VOC and 60 of them are considered unknown. The 10 unknown object classes listed in FIG. 9 are used in the example implementation, namely “truck,” “bench,” “zebra,” “giraffe,” “umbrella,” “microwave,” “oven,” “sink,” “refrigerator,” and “traffic light.”

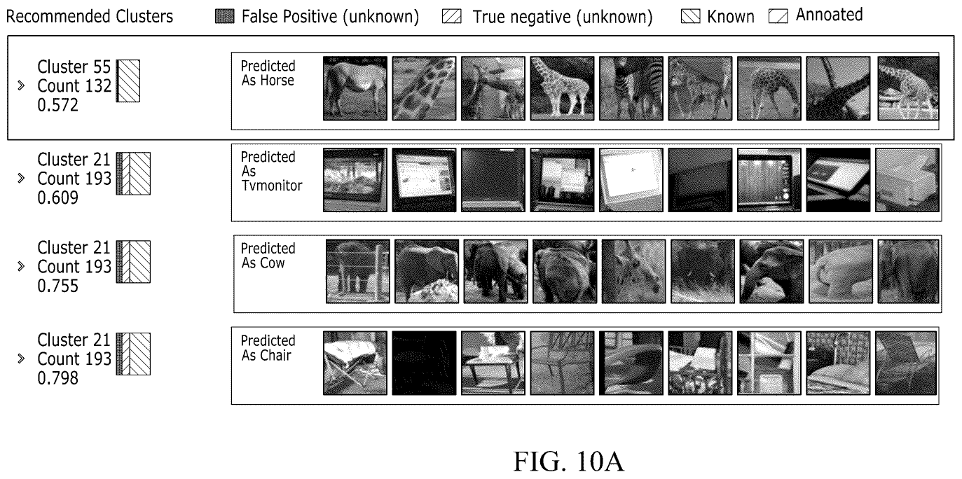

FIGS. 10A, 10B, 10C, and 10D illustrate various moments in time during a process of identifying and annotating giraffes, based on the given implementation of the open-world object detection system introduced in FIG. 9, according to some embodiments.

FIG. 10A-10D illustrate the execution of the open-world object detection system from both a perspective of a user that is using a user interface, and a perspective of the processors that have program instructions that cause the open-world object detection system to be executed. In general, and following the execution of the object detection model of the larger system, bounding boxes were organized into clusters that were then ranked. An unknown object class, namely “giraffes,” is then identified from a selected cluster. Text-based pseudo-labels from the same cluster, from CLIP-based recommendations, and from patch feature-based recommendations are then generated, followed by the training of the classifier based on those text-based pseudo-labels.

As shown in FIG. 10A, a user may begin by utilizing a bar chart in a Statistic View of the user interface to filter out bounding boxes with low objectness scores. Remaining bounding boxes are grouped into clusters, which are then sorted by median entropy value. The user then selects the top cluster as a cluster that includes unknown objects (from the perspective of the object detection model) of interest.

As shown in FIG. 10B, the user then examines details of the top cluster using a Cluster Detail View and a Projection View of the user interface. During this analysis, the user may determine that a majority of known objects within that top cluster are horses. However, there are also some animals belonging to unknown object classes that were misclassified as horses by the object detection model, and with high confidence. In the particular example shown in FIG. 10B, the misclassified animals are predominantly giraffes. As such, the user submits a text-based pseudo-label of “giraffe” to the open-world object detection system via the user interface.

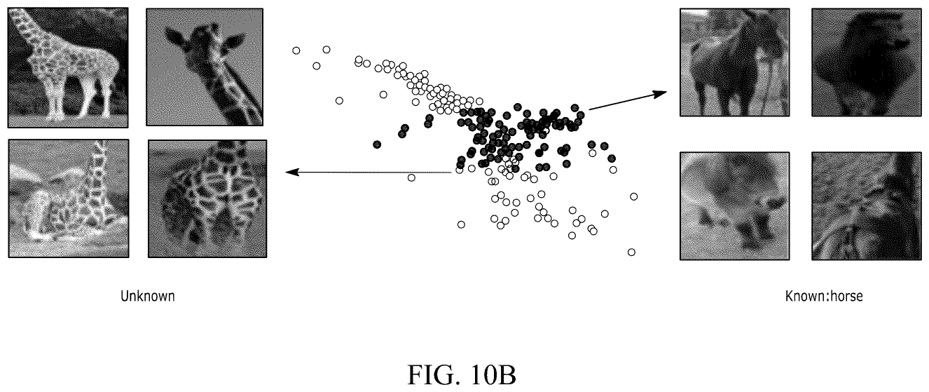

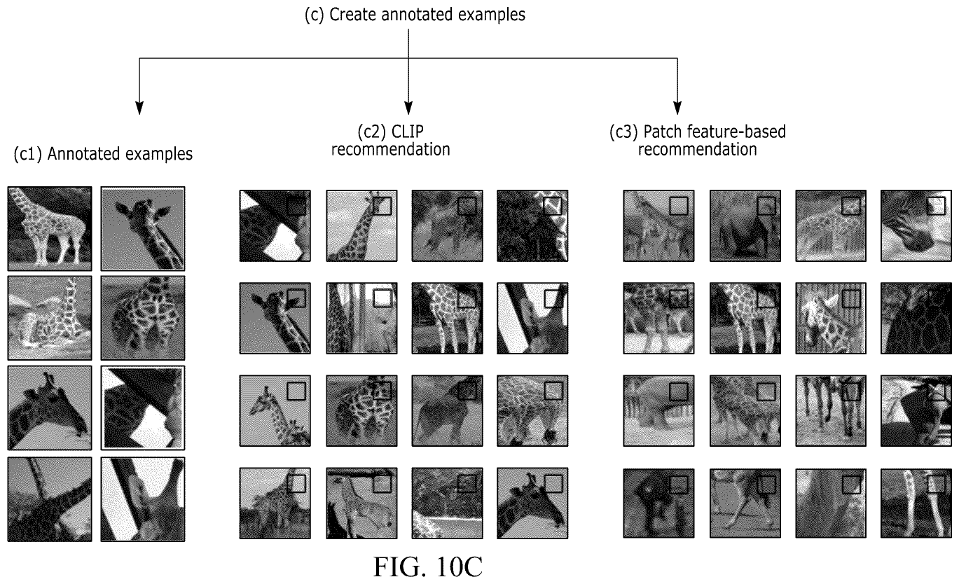

From a perspective of the user using the user interface, the user may select a first few giraffes to initiate a link between the text-based pseudo-label of “giraffe” and image patches that include giraffes. The system then expands this dataset via either the CLIP-based recommendation method (labeled as “CLIP” in FIGS. 11 and 12) or the feature-based recommendation method (labeled as “k-NN” in FIGS. 11 and 12), both shown in FIG. 10C.

FIG. 10D then illustrates a subsequent training of the classifier. In the particular implementation shown in FIG. 9-12, the classifier is implemented as an MLP.

FIG. 11 is a table that illustrates performance during the given implementation of the open-world object detection system introduced in FIG. 9, wherein the system is measured using an F1 metric. FIG. 12 is a table that illustrates performance during the given implementation of the open-world object detection system introduced in FIG. 9, wherein the system is measured using an mAP metric.

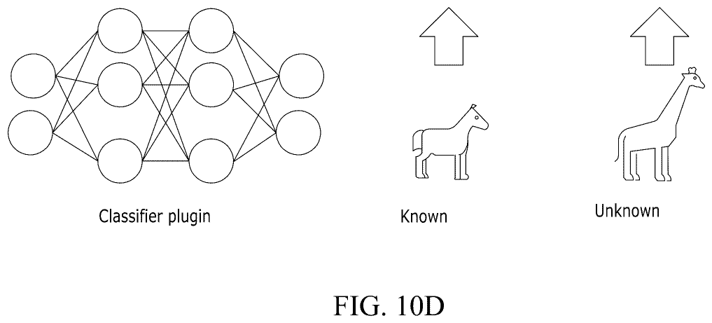

FIG. 13 illustrates a schematic diagram of an interaction between a computer-controlled machine and a control system, according to some embodiments.

The methods and systems disclosed herein can be used in many different applications. This section provides some practical applications of the proposed system.

The methods and systems disclosed herein can be used in many different applications. Determining known and unknown object classes can be useful for a plethora of technologies, examples of which are illustrated in FIG. 13-19. FIG. 13 depicts a schematic diagram of an interaction between a computer-controlled machine 1300 and a control system 1302. Computer-controlled machine 1300 includes actuator 1304 and sensor 1306. Actuator 1304 may include one or more actuators and sensor 1306 may include one or more sensors. Sensor 1306 is configured to sense a condition of computer-controlled machine 1300. Sensor 1306 may be configured to sense ID and/or OOD data, and the corresponding processors can be configured to determine whether the data is ID or OOD according to the teachings herein. Sensor 1306 may be configured to encode the sensed condition into sensor signals 1308 and to transmit sensor signals 1308 to control system 1302. Non-limiting examples of sensor 1306 include a camera, video sensor, radar, LiDAR, ultrasonic and motion sensors, temperature sensors, and the like. In one embodiment, sensor 1306 is an optical sensor configured to sense optical images of an environment proximate to computer-controlled machine 1300.

Control system 1302 is configured to receive sensor signals 1308 from computer-controlled machine 1300. As set forth below, control system 1302 may be further configured to compute actuator control commands 1310 depending on the sensor signals and to transmit actuator control commands 1310 to actuator 1304 of computer-controlled machine 1300.

As shown in FIG. 13, control system 1302 includes receiving unit 1312. Receiving unit 1312 may be configured to receive sensor signals 1308 from sensor 1306 and to transform sensor signals 1308 into input signals x. In an alternative embodiment, sensor signals 1308 are received directly as input signals x without receiving unit 1312. Each input signal x may be a portion of each sensor signal 1308. Receiving unit 1312 may be configured to process each sensor signal 1308 to product each input signal x. Input signal x may include data corresponding to an image recorded by sensor 1306.

Control system 1302 includes an open-world object detection system 1314.

Open-world object detection system 1314 may be configured to classify input signals x into one or more labels using a machine learning algorithm, such as the object detection models and classifiers described above. Open-world object detection system 1314 is configured to be parametrized by parameters, such as those described above (e.g., parameter θ). Parameters θ may be stored in and provided by non-volatile storage 1316. Open-world object detection system 1314 is configured to determine output signals y from input signals x. Each output signal y includes information that assigns one or more labels to each input signal x. Open-world object detection system 1314 may transmit output signals y to conversion unit 1318. Conversion unit 1318 is configured to covert output signals y into actuator control commands 1310. Control system 1302 is configured to transmit actuator control commands 1310 to actuator 1304, which is configured to actuate computer-controlled machine 1300 in response to actuator control commands 1310. In another embodiment, actuator 1304 is configured to actuate computer-controlled machine 1300 based directly on output signals y.

Upon receipt of actuator control commands 1310 by actuator 1304, actuator 1304 is configured to execute an action corresponding to the related actuator control command 1310. Actuator 1304 may include a control logic configured to transform actuator control commands 1310 into a second actuator control command, which is utilized to control actuator 1304. In one or more embodiments, actuator control commands 1310 may be utilized to control a display instead of or in addition to an actuator.

In another embodiment, control system 1302 includes sensor 1306 instead of or in addition to computer-controlled machine 1300 including sensor 1306. Control system 1302 may also include actuator 1304 instead of or in addition to computer-controlled machine 1300 including actuator 1304.

As shown in FIG. 13, control system 1302 also includes processor 1320 and memory 1322. Processor 1320 may include one or more processors. Memory 1322 may include one or more memory devices. The open-world object detection system 1314 of one or more embodiments may be implemented by control system 1302, which includes non-volatile storage 1316, processor 1320 and memory 1322.

Non-volatile storage 1316 may include one or more persistent data storage devices such as a hard drive, optical drive, tape drive, non-volatile solid-state device, cloud storage or any other device capable of persistently storing information. Processor 1320 may include one or more devices selected from high-performance computing (HPC) systems including high-performance cores, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on computer-executable instructions residing in memory 1322. Memory 1322 may include a single memory device or a number of memory devices including, but not limited to, random access memory (RAM), volatile memory, non-volatile memory, static random access memory (SRAM), dynamic random access memory (DRAM), flash memory, cache memory, or any other device capable of storing information. Moreover, processor 1320 and memory 1322 may be configured to provide collected data to one or more other computing devices that are configured to train and/or validate the machine learning model within domain-specific embodiments shown throughout FIG. 13-19. Such collected data may be used to generate training datasets and validation datasets for various stages in preparing and executing a machine learning model into industry-grade applications. Within a context described herein with regard to edge case detection, processor 1320 and memory 1322 may be coupled to or otherwise remotely connected to computing devices that may then conduct validation processes such as those described above.

Processor 1320 may be configured to read into memory 1322 and execute computer-executable instructions residing in non-volatile storage 1316 and embodying one or more machine-learning algorithms and/or methodologies of one or more embodiments. Non-volatile storage 1316 may include one or more operating systems and applications. Non-volatile storage 1316 may store compiled and/or interpreted from computer programs created using a variety of programming languages and/or technologies, including, without limitation, and either alone or in combination, Java, C, C++, C #, Objective C, Fortran, Pascal, Java Script, Python, Perl, and PL/SQL.

Upon execution by processor 1320, the computer-executable instructions of non-volatile storage 1316 may cause control system 1302 to implement one or more of the machine-learning algorithms and/or methodologies as disclosed herein. Non-volatile storage 1316 may also include machine-learning data (including data parameters) supporting the functions, features, and processes of the one or more embodiments described herein.

The program code embodying the algorithms and/or methodologies described herein is capable of being individually or collectively distributed as a program product in a variety of different forms. The program code may be distributed using a computer readable storage medium having computer readable program instructions thereon for causing a processor to carry out aspects of one or more embodiments. Computer readable storage media, which is inherently non-transitory, may include volatile and non-volatile, and removable and non-removable tangible media implemented in any method or technology for storage of information, such as computer-readable instructions, data structures, program modules, or other data. Computer readable storage media may further include RAM, ROM, erasable programmable read-only memory (EPROM), electrically erasable programmable read-only memory (EEPROM), flash memory or other solid state memory technology, portable compact disc read-only memory (CD-ROM), or other optical storage, magnetic cassettes, magnetic tape, magnetic disk storage or other magnetic storage devices, or any other medium that can be used to store the desired information and which can be read by a computer. Computer readable program instructions may be downloaded to a computer, another type of programmable data processing apparatus, or another device from a computer readable storage medium or to an external computer or external storage device via a network.

Computer readable program instructions stored in a computer readable medium may be used to direct a computer, other types of programmable data processing apparatus, or other devices to function in a particular manner, such that the instructions stored in the computer readable medium produce an article of manufacture including instructions that implement the functions, acts, and/or operations specified in the flowcharts or diagrams. In certain alternative embodiments, the functions, acts, and/or operations specified in the flowcharts and diagrams may be re-ordered, processed serially, and/or processed concurrently consistent with one or more embodiments. Moreover, any of the flowcharts and/or diagrams may include more or fewer nodes or blocks than those illustrated consistent with one or more embodiments.

The processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

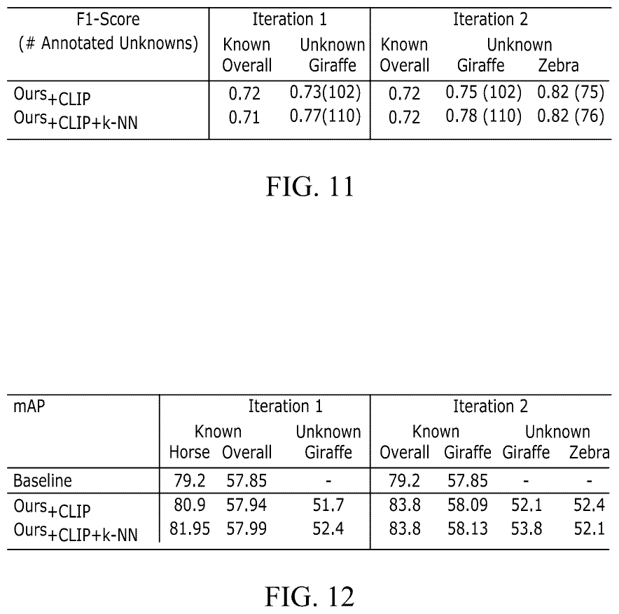

FIG. 14 depicts a schematic diagram of control system 1302 configured to control vehicle 1400, which may be an at least partially autonomous vehicle or an at least partially autonomous robot. Vehicle 1400 includes actuator 1304 and sensor 1306. Sensor 1306 may include one or more video sensors, cameras, radar sensors, ultrasonic sensors, LiDAR sensors, and/or position sensors (e.g. GPS). One or more of the one or more specific sensors may be integrated into vehicle 1400. In the context of sign-recognition and processing as described herein, the sensor 1306 is a camera mounted to or integrated into the vehicle 1400. Alternatively or in addition to one or more specific sensors identified above, sensor 1306 may include a software module configured to, upon execution, determine a state of actuator 1304. One non-limiting example of a software module includes a weather information software module configured to determine a present or future state of the weather proximate vehicle 1400 or other location.

Open-world object detection system 1314 of control system 1302 of vehicle 1400 may be configured to detect objects in the vicinity of vehicle 1400 dependent on input signals x. In such an embodiment, output signal y may include information characterizing the vicinity of objects to vehicle 1400. Actuator control command 1310 may be determined in accordance with this information. The actuator control command 1310 may be used to avoid collisions with the detected objects.

In embodiments where vehicle 1400 is an at least partially autonomous vehicle, actuator 1304 may be embodied in a brake, a propulsion system, an engine, a drivetrain, or a steering of vehicle 1400. Actuator control commands 1310 may be determined such that actuator 1304 is controlled such that vehicle 1400 avoids collisions with detected objects. Detected objects may also be classified according to what open-world object detection system 1314 deems them most likely to be, such as pedestrians or trees. The actuator control commands 1310 may be determined depending on the classification. In a scenario where an adversarial attack may occur, the system described above may be further trained to better detect objects or identify a change in lighting conditions or an angle for a sensor or camera on vehicle 1400.

In other embodiments where vehicle 1400 is an at least partially autonomous robot, vehicle 1400 may be a mobile robot that is configured to carry out one or more functions, such as flying, swimming, diving and stepping. The mobile robot may be an at least partially autonomous lawn mower or an at least partially autonomous cleaning robot. In such embodiments, the actuator control command 1310 may be determined such that a propulsion unit, steering unit and/or brake unit of the mobile robot may be controlled such that the mobile robot may avoid collisions with identified objects.

In another embodiment, vehicle 1400 is an at least partially autonomous robot in the form of a gardening robot. In such embodiment, vehicle 1400 may use an optical sensor as sensor 1306 to determine a state of plants in an environment proximate vehicle 1400. Actuator 1304 may be a nozzle configured to spray chemicals. Depending on an identified species and/or an identified state of the plants, actuator control command 1310 may be determined to cause actuator 1304 to spray the plants with a suitable quantity of suitable chemicals.

Vehicle 1400 may be an at least partially autonomous robot in the form of a domestic appliance. Non-limiting examples of domestic appliances include a washing machine, a stove, an oven, a microwave, or a dishwasher. In such a vehicle 1400, sensor 1306 may be an optical sensor configured to detect a state of an object which is to undergo processing by the household appliance. For example, in the case of the domestic appliance being a washing machine, sensor 1306 may detect a state of the laundry inside the washing machine. Actuator control command 1310 may be determined based on the detected state of the laundry.

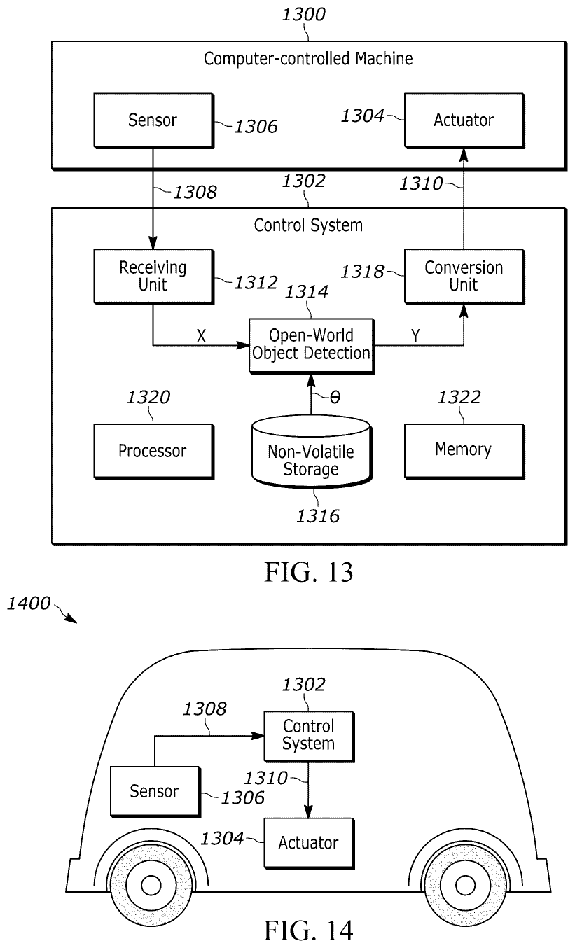

FIG. 15 depicts a schematic diagram of control system 1302 configured to control system 1500 (e.g., manufacturing machine), such as a punch cutter, a cutter or a gun drill, of manufacturing system 1502, such as part of a production line. Control system 1302 may be configured to control actuator 1304, which is configured to control system 1500 (e.g., manufacturing machine).

Sensor 1306 of system 1500 (e.g., manufacturing machine) may be an optical sensor configured to capture one or more properties of manufactured product 1504. Open-world object detection system 1314 may be configured to determine a state of manufactured product 1504 from one or more of the captured properties. Actuator 1304 may be configured to control system 1500 (e.g., manufacturing machine) depending on the determined state of manufactured product 1504 for a subsequent manufacturing step of manufactured product 1504. The actuator 1304 may be configured to control functions of system 1500 (e.g., manufacturing machine) on subsequent manufactured product 1506 of system 1500 (e.g., manufacturing machine) depending on the determined state of manufactured product 1504.

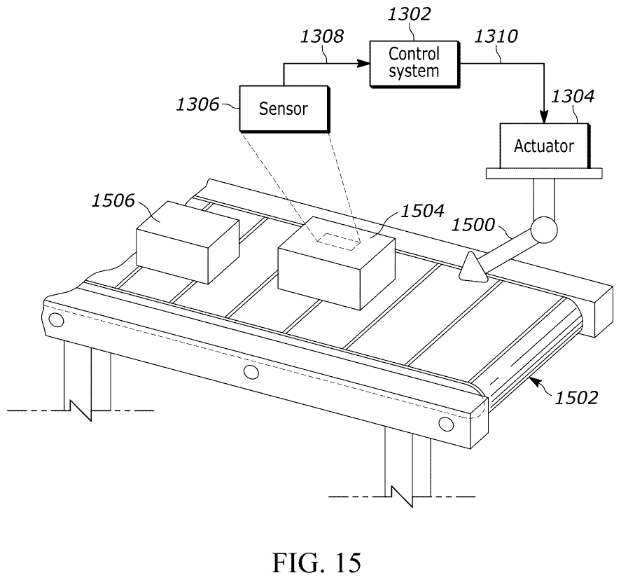

FIG. 16 depicts a schematic diagram of control system 1302 configured to control power tool 1600, such as a power drill or driver, that has an at least partially autonomous mode. Control system 1302 may be configured to control actuator 1304, which is configured to control power tool 1600.

Sensor 1306 of power tool 1600 may be an optical sensor configured to capture one or more properties of work surface 1602 and/or fastener 1604 being driven into work surface 1602. Open-world object detection system 1314 within control system 1302 may be configured to determine a state of work surface 1602 and/or fastener 1604 relative to work surface 1602 from one or more of the captured properties. The state may be fastener 1604 being flush with work surface 1602. The state may alternatively be hardness of work surface 1602. Actuator 1604 may be configured to control power tool 1600 such that the driving function of power tool 1600 is adjusted depending on the determined state of fastener 1604 relative to work surface 1602 or one or more captured properties of work surface 1602. For example, actuator 1604 may discontinue the driving function if the state of fastener 1604 is flush relative to work surface 1602. As another non-limiting example, actuator 1604 may apply additional or less torque depending on the hardness of work surface 1602.

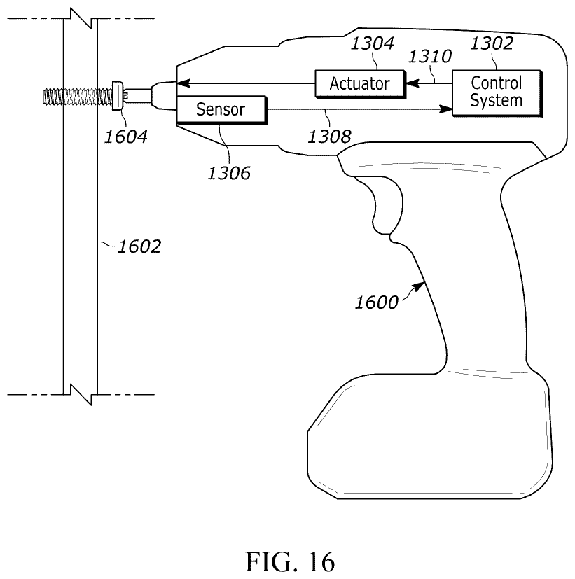

FIG. 17 depicts a schematic diagram of control system 1302 configured to control automated personal assistant 1700. Control system 1302 may be configured to control actuator 1304, which is configured to control automated personal assistant 1700. Automated personal assistant 1700 may be configured to control a domestic appliance, such as a washing machine, a stove, an oven, a microwave or a dishwasher.

Sensor 1306 may be an optical sensor and/or an audio sensor. The optical sensor may be configured to receive video images of gestures 1704 of user 1702. The audio sensor may be configured to receive a voice command of user 1702.

Control system 1302 of automated personal assistant 1700 may be configured to determine actuator control commands 1310 configured to control system 1302. Control system 1302 may be configured to determine actuator control commands 1310 in accordance with sensor signals 1308 of sensor 1306. Automated personal assistant 1700 is configured to transmit sensor signals 1308 to control system 1302. Open-world object detection system 1314 of control system 1302 may be configured to execute a gesture recognition algorithm to identify gesture 1704 made by user 1702, to determine actuator control commands 1310, and to transmit the actuator control commands 1310 to actuator 1304. Open-world object detection system 1314 may be configured to retrieve information from non-volatile storage in response to gesture 1704 and to output the retrieved information in a form suitable for reception by user 1702.

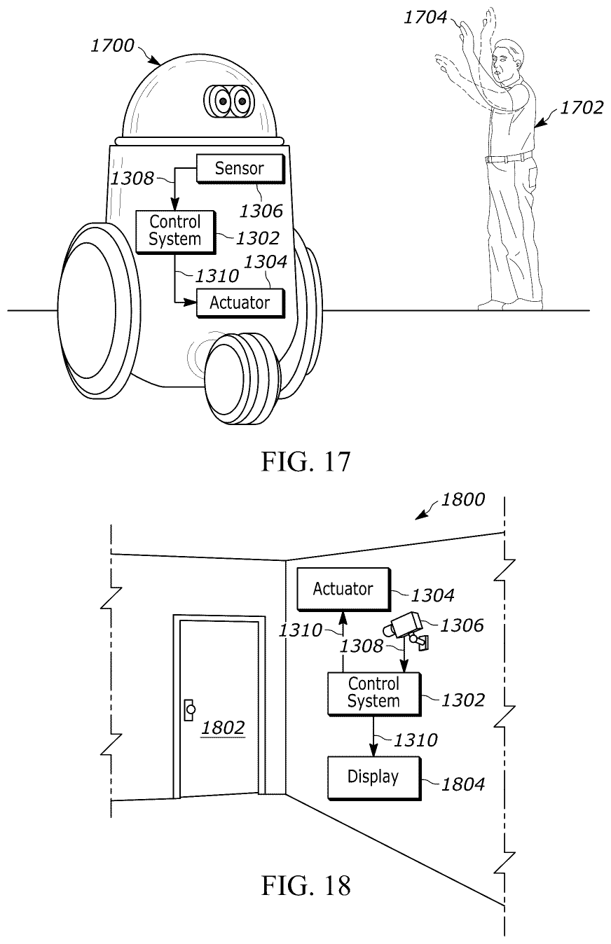

FIG. 18 depicts a schematic diagram of control system 1302 configured to control monitoring system 1800. Monitoring system 1800 may be configured to physically control access through door 1802. Sensor 1306 may be configured to detect a scene that is relevant in deciding whether access is granted. Sensor 1306 may be an optical sensor configured to generate and transmit image and/or video data. Such data may be used by control system 1302 to detect a person's face.

Open-world object detection system 1314 of control system 1302 of monitoring system 1800 may be configured to interpret the image and/or video data by matching identities of known people stored in non-volatile storage 1316, thereby determining an identity of a person. Open-world object detection system 1314 may be configured to generate and an actuator control command 1310 in response to the interpretation of the image and/or video data. Control system 1302 is configured to transmit the actuator control command 1310 to actuator 1304. In this embodiment, actuator 1304 may be configured to lock or unlock door 1802 in response to the actuator control command 1310. In other embodiments, a non-physical, logical access control is also possible.

Monitoring system 1800 may also be a surveillance system. In such an embodiment, sensor 1306 may be an optical sensor configured to detect a scene that is under surveillance and control system 1302 is configured to control display 1804. Open-world object detection system 1314 is configured to determine a classification of a scene, e.g. whether the scene detected by sensor 1306 is suspicious. Control system 1302 is configured to transmit an actuator control command 1310 to display 1804 in response to the classification. Display 1804 may be configured to adjust the displayed content in response to the actuator control command 1310. For instance, display 1804 may highlight an object that is deemed suspicious by open-world object detection system 1314. Utilizing an embodiment of the system disclosed, the surveillance system may predict objects at certain times in the future showing up.

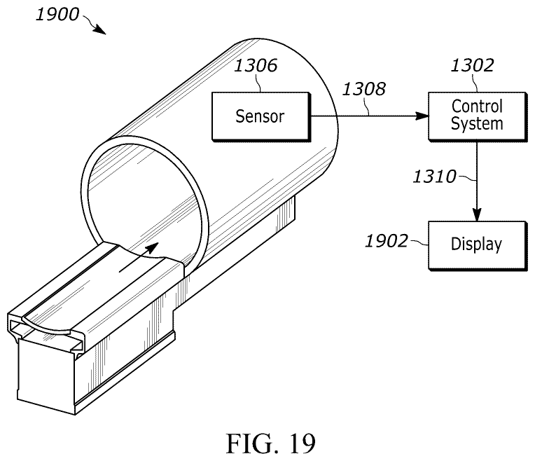

FIG. 19 depicts a schematic diagram of control system 1302 configured to control imaging system 1900, for example an MRI apparatus, x-ray imaging apparatus or ultrasonic apparatus. Sensor 1306 may, for example, be an imaging sensor. Open-world object detection system 1314 may be configured to determine a classification of all or part of the sensed image. Open-world object detection system 1314 may be configured to determine or select an actuator control command 1310 in response to the classification obtained by the pre-trained neural network or trained classifier. For example, open-world object detection system 1314 may interpret a region of a sensed image to be potentially anomalous. In this case, actuator control command 1310 may be determined or selected to cause display 1902 to display the imaging and highlighting the potentially anomalous region.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A computer-implemented method for training an open-world object detection system, the method comprising:
receiving, as outputs from an object detection model, image-based data samples and bounding boxes of the image-based data samples, wherein a first subset of the bounding boxes correspond to known object classes of the object detection model and a second subset of the bounding boxes correspond to unknown object classes of the object detection model;
organizing the bounding boxes into clusters, wherein respective ones of the bounding boxes the clusters have shared semantic meanings;
providing a portion of the clusters to a computing device associated with a user that corresponds to the unknown object classes of the object detection model;
receiving, from the computing device associated with the user, data indicating text-based pseudo-labels for the portion of the clusters;
training a classifier to learn additional object classes based on the data indicating the text-based pseudo-labels, the first subset of the bounding boxes, and the second subset of bounding boxes; and
providing the learned, additional object classes to the open-world object detection system to augment a total number of known object classes of the open-world object detection system.

2. The computer-implemented method of claim 1, wherein the classifier is a multi-layer perceptron.

3. The computer-implemented method of claim 1, wherein the training the classifier comprises upsampling the data indicating the text-based pseudo-labels.

4. The computer-implemented method of claim 1, wherein:
the method further comprises extracting feature vectors from the bounding boxes; and
the training the classifier comprises:
providing the feature vectors to the classifier; and
executing the classifier to output, for respective ones of the feature vectors, a probability of membership into a given one of the unknown object classes, based on the data indicating the text-based pseudo-labels.

5. The computer-implemented method of claim 1, wherein:
the method further comprises receiving, as additional outputs from the object detection model, feature maps of the image-based data samples; and
the organizing the bounding boxes into clusters comprises:
computing an average of features within respective ones of the bounding boxes, based on the feature maps; and
outputting high-dimensional representations for the respective ones of the bounding boxes.

6. The computer-implemented method of claim 5, wherein the organizing the bounding boxes into clusters further comprises projecting the high-dimensional representations into two-dimensional latent vectors.

7. The computer-implemented method of claim 6, wherein the organizing the bounding boxes into clusters further comprises grouping the two-dimensional latent vectors into the clusters based on the shared semantic meanings.

8. The computer-implemented method of claim 7, wherein the organizing the bounding boxes into clusters further comprises filtering out respective ones of the grouped clusters that pertain to the known object classes of the object detection model.

9. The computer-implemented method of claim 7, wherein the organizing the bounding boxes into clusters further comprises:
ranking the clusters by one or more of a false positive rate, entropy, or maximum confidence; and
providing the ranked clusters to the user.

10. The computer-implemented method of claim 1, wherein, responsive to receiving, from the computing device associated with the user, a first text-based pseudo-label that corresponds to a first bounding box of a first cluster, the method further comprises:
executing a vision-language model to output a ranking of other bounding boxes within the first cluster; and
providing the ranked other bounding boxes to the computing device associated with the user.

11. The computer-implemented method of claim 10, wherein the executing the vision-language model comprises:
encoding the first text-based pseudo-label to generate a text embedding;
encoding other bounding boxes of the first cluster to generate an image embedding;
computing a cosine similarity between the text embedding and the image embedding;
ranking the other bounding boxes based on the cosine similarity; and
providing the ranked other bounding boxes to the user.

12. The computer-implemented method of claim 1, wherein, responsive to receiving, from the computing device associated with the user, a first text-based pseudo-label that corresponds to a first bounding box of a first cluster, the method further comprises:
identifying other bounding boxes of the first cluster that are close to the first bounding box in a two-dimensional projection space; and
providing the identified other bounding boxes to the computing device associated with the user.

13. A computer-implemented method for training an open-world object detection system, the method comprising:
executing an object detection model to output bounding boxes from image-based data samples;
determining a first subset of the bounding boxes that correspond to known object classes of the object detection model;
determining a second subset of the bounding boxes that correspond to unknown object classes of the object detection model;
training a classifier to learn additional object classes based on data indicating text-based pseudo-labels of the second subset of the bounding boxes, the first subset of the bounding boxes, and the second subset of the bounding boxes; and
providing the learned, additional object classes to the open-world object detection system to augment a total number of known object classes of the open-world object detection system.

14. The computer-implemented method of claim 13, wherein the determining the first subset of the bounding boxes that correspond to the known object classes of the object detection model comprises:
identifying that respective bounding boxes of the first subset overlap, at least above a threshold amount, with ground truth bounding boxes, wherein the ground truth bounding boxes indicate a presence of one or more objects within the known object classes of the object detection model.

15. The computer-implemented method of claim 13, wherein the determining the second subset of the bounding boxes that correspond to the unknown object classes of the object detection model comprises:
identifying that respective bounding boxes of the second subset do not overlap with ground truth bounding boxes, wherein the ground truth bounding boxes indicate a presence of one or more objects within the known object classes of the object detection model.

16. The computer-implemented method of claim 13, wherein the determining the second subset of the bounding boxes that correspond to the unknown object classes of the object detection model comprises:
filtering out a given one of the bounding boxes from the second subset based on a corresponding objectness score, output by the object detection model, being below a threshold value.

17. The computer-implemented method of claim 13, wherein the determining the second subset of the bounding boxes that correspond to the unknown object classes of the object detection model comprises:
filtering out a given one of the bounding boxes from the second subset based on a non-maximum suppression technique.

18. The computer-implemented method of claim 13, further comprising:
providing the second subset of the bounding boxes to a computing device associated with a user; and
receiving, from the computing device associated with the user, the data indicating the text-based pseudo-labels that correspond to respective semantic meanings of the second subset of the bounding boxes.

19. A system, comprising:
a processor; and
memory storing program instructions that, when executed by the processor, cause the processor to:
execute an object detection model to output bounding boxes from image-based data samples;
determine a first subset of the bounding boxes that correspond to known object classes of the object detection model;
determine a second subset of the bounding boxes that correspond to unknown object classes of the object detection model;
train a classifier to learn additional object classes based on data indicating text-based pseudo-labels of the second subset of the bounding boxes, the first subset of the bounding boxes, and the second subset of the bounding boxes; and
provide the learned, additional object classes to the object detection model to augment a total number of known object classes of the object detection model.

20. The system of claim 19, wherein the classifier is a multi-layer perceptron.
